(19) United States
(12) Patent Application Publication
(10) Pub. No.: US 2024/0177327 A1
(43) Pub. Date: May 30, 2024

(54) METHOD, SYSTEM AND TERMINAL FOR MEASURING SHAPE DISSIMILARITY OF COMPLEX TREE-LIKE OBJECTS

(71) Applicant: University of Electronic Science and Technology of China, Yangtze River Delta Research Institute, Huzhou City (CN)

(72) Inventors: Guan WANG, Huzhou City (CN); Ning XIE, Huzhou City (CN)

(21) Appl. No.: 18/383,112

(22) Filed: Oct. 24, 2023

(30) Foreign Application Priority Data
Nov. 21, 2022 (CN) 2022114638671

(51) Int. Cl. G06T 7/55; G06T 7/64; G06T 7/73

(52) U.S. Cl. CPC G06T 7/55; G06T 7/64; G06T 7/75; G06T 2207/20036; G06T 2207/30016; G06T 2207/30188

(57) ABSTRACT

Disclosure relates to the fields of computer graphics, three-dimensional vision and medical image processing, and discloses a method, a system and a terminal for measuring shape dissimilarity of complex tree-like objects. The method includes: extracting skeleton curve information from a trunk of a 3D model of a tree-like object, wherein each trunk skeleton curve describes spatial position information and thickness of the trunk; representing the tree-like object using the trunk skeleton curve as a basic structural unit in a hierarchical iterative manner; categorizing the tree-like object as either simple or complex based on the number of layers; wherein, a simple tree-like object is composed of a main trunk and multiple side branches, a complex tree-like object is composed of a main trunk and multiple sub-trees, and each sub-tree is further composed of a trunk and multiple sub-trees/side branches.

### CROSS-REFERENCE TO RELATED APPLICATIONS

This application claims priority to Chinese Utility Application No. 202211463867.1, filed on Nov. 21, 2022. The disclosure of the application is incorporated herein for all purposes by reference in its entirety.

### TECHNICAL FIELD

The present disclosure relates to the fields of computer graphics, three-dimensional vision and medical image processing, and more particularly, to a method, a system and a terminal for measuring shape dissimilarity of complex tree-like objects.

### BACKGROUND

Currently, tree-like objects are ubiquitously found in the real world, including natural trees, plants, as well as vascular tissues and neural systems within the human body. Their digital representations and constructions are widely applied in areas such as plant biology, urban modeling, movie and game production, and medical diagnosis. The analysis and construction of the morphological appearance of tree-like objects have also become significant research topics in the fields of computer graphics, three-dimensional vision, and medical image processing. In computer graphics, constructing three-dimensional tree or plant models can effectively enhance the realism of 3D virtual scenes, thereby providing a better user experience during virtual reality navigation. In medical image processing, some studies indicate that the morphology of neural systems, including their geometric and topological structures, determines how neurons integrate information, further elucidating the activities and functionalities of the brain. Additionally, statistical analysis of neural morphology is crucial for understanding brain functions and healthy cognitive representation. Changes in neural morphology could be not only a result of normal aging but also potentially pathological, such as in cases of Alzheimer's disease and dementia.

One critical aspect of modeling and analyzing the shape of tree-like objects is the calculation of shape dissimilarity values between two tree-like objects. Current technologies primarily focus on objects with fixed topologies, where the described objects only exhibit variations in geometric information like bending and stretching deformations. The morphology of tree-like objects is more challenging since they exhibit variations both in geometric and topological structures. This makes it a challenging task to calculate the shape dissimilarity values between different tree-like objects. To address this issue, some works have represented tree-like objects as graph structures, where nodes represent branching points of the tree-like objects, and edges represent the geometric information between different branching points. However, due to computational complexity, this kind of dissimilarity calculation based on graph structures is NP-hard. Consequently, these algorithms are limited to the analysis and modeling of simple tree-like objects. Some other works have extended this basis for handling 3D tree models, where the matching and deformation operations between tree models are calculated separately, leading to suboptimal results. The current methods usually adopt edge collapse and node splitting to describe changes in topological structures, resulting in structural shrinkage phenomena during the transition between different tree-like objects post-dissimilarity calculation.

From the aforementioned analysis, the problems and deficiencies in the existing technologies are:
(1) Due to computational complexity, existing algorithm frameworks are only limited to shape analysis and modeling of simple tree-like objects, making dissimilarity calculations based on graph structures NP-hard.
(2) In existing methods for handling 3D tree models, morphological matching and deformation operations between tree models are calculated separately, leading to suboptimal results.
(3) Current technologies generally adopt edge collapse and node splitting for describing changes in topological structures, causing structural shrinkage phenomena during the transition between different tree-like objects post-dissimilarity calculation.
(4) Existing methods for measuring shape dissimilarity of complex tree-like objects are unable to effectively combine geometric information and topological structures for measurement.

### SUMMARY

In view of the problems existing in the prior art, the present disclosure provides a method, a system and a terminal for measuring shape dissimilarity of complex tree-like objects.

The present disclosure provides a method for measuring shape dissimilarity of complex tree-like objects, which comprises: extracting skeleton curve information from a trunk of a 3D model of a tree-like object, wherein each trunk skeleton curve describes spatial position information and thickness of the trunk; representing the tree-like object using the trunk skeleton curve as a basic structural unit in a hierarchical iterative manner; categorizing the tree-like object as either simple or complex based on the number of layers; wherein, a simple tree-like object is composed of a main trunk and multiple side branches, a complex tree-like object is composed of a main trunk and multiple sub-trees, and each sub-tree is further composed of a trunk and multiple sub-trees/side branches.

Furthermore, the tree-like object comprises a 3D tree model and a neural system, and the shape dissimilarity of complex tree-like objects comprises differences in geometric information and topological information.

Furthermore, the method for measuring shape dissimilarity of complex tree-like objects comprises the following steps:
Step One: calculating the shape dissimilarity of the trunks;
Step Two: calculating the shape dissimilarity of simple tree-like objects;
Step Three: calculating the shape dissimilarity of complex tree-like objects.

Furthermore, in Step One, calculating the shape dissimilarity of the trunks comprises: considering each trunk β as a continuous curve equipped with trunk radius information in a three-dimensional Euclidean space: β:[0, 1]→ [symbol] [symbol] × [symbol] ⁺, parametrically represented as β=(f(s), r(s))=(x(s), y(s), z(s), r(s)); where x(s), y(s), z(s) is coordinate information of a sample point of the skeleton curve, and r(s) is a radius of the trunk corresponding to the sample point, s ∈ [0, 1] representing a scale value along the arc length of the curve β.

In order to describe the bending and stretching shapes of the trunks, the curve f(s) is represented as the corresponding Square Root Velocity Function (SRVF), mathematically represented as:

$$SRVF ( s ) = \{ \begin{matrix}\frac{{f}^{′} ( s )}{\sqrt{‖ {f}^{′} ( s ) ‖}} & if {f}^{′} ( s ) exists and ‖ {f}^{′} ( s ) ‖ \text{?} 0 \\ 0 , & otherwise\end{matrix}$$

$$\text{?} \text{indicates text missing or illegible when filed}$$

elastic curve of the trunk β=(f(s), r(s)) is represented as q=(SRVF(s), r(s));
according to the theory of elastic curve, the dissimilarity measurement between two elastic curves uses the Euclidean standard; an optimal matching problem between two trunk skeleton curves β₁ and β₂ is a process of finding the re-parameterization function γ:

$$γ \text{?} = arg min ‖ {q}_{1} - γ ( {q}_{2} ) ‖ ;$$

$$\text{?} \text{indicates text missing or illegible when filed}$$

therefore, a distance between the two curves is defined as

$${d}_{s} ( \text{?} , {q}_{2} ) = ‖ {q}_{1} - γ \text{?} ( {q}_{2} ) ‖ ,$$

$$\text{?} \text{indicates text missing or illegible when filed}$$

based on a distance metric standard, a matching relationship and morphological transition situation between the two trunk curves are obtained.

Furthermore, in Step Two, calculating the shape dissimilarity of simple tree-like objects comprises:
a simple tree comprises a main trunk and n side branches, denoted as (q, τ), where q=[q₀, q₁, q₂, . . . , qₙ], τ=[τ₁, τ₂, . . . , τₙ], q₀ is a SRVF representation of the main trunk, and qₜ is a SRVF representation of the side branches;
for two given simple trees (q^{a}, τ^{a}) and (q^{b}, τ^{b}), a distance matrix is constructed to describe the morphological differences between the branches of the two trees, allowing a branch to match with a zero branch, and the optimal matching between the branches of the two trees is solved using a linear assignment problem; if the ith branch of the first tree corresponds to the j(i)th branch of the second tree, the shape dissimilarity between the two simple trees is denoted as:

$${d}_{st} ( {q}^{a} , {q}^{b} ) = {λ}_{s} {d}_{s} ( {q}_{0}^{a} , {q}_{0}^{b} ) + {λ}_{z} {{\sum }^{n}}_{i = \text{?}} {d}_{\text{?}} ( {q}_{i}^{a} , {q}_{j ( i )}^{b} ) + {λ}_{\text{?}} {\sum }_{i = 1}^{n} {( {τ}_{i}^{a} - {τ}_{j ( i )}^{b} )}^{2}$$

$$\text{?} \text{indicates text missing or illegible when filed}$$

where n−nₐ+n_{b} represents the total number of branches of the two trees, dₛ represents the elastic distance between two branches, λ₁, λ₂, and λ₃, are weights assigned to the differences of the main trunk, the sum of the side branch differences, and the sum of the side branch growth position differences, respectively, in calculating the shape dissimilarity of the sub-trees; a transition shape change between the two simple trees is obtained through this formula.

Furthermore, in Step Three, calculating the shape dissimilarity of complex tree-like objects comprises:
based on the representation of simple tree-like objects, a complex tree-like object T is recursively represented as:

$${T}^{k} = \{ {q}_{0} , ( {T}_{1}^{( k - 1 )} , {τ}_{1} ) , ( {T}_{2}^{( k - 1 )} , {τ}_{2} ) , … , ( {T}_{i}^{( k - 1 )} , {τ}_{i} ) , … , ( {T}_{n}^{( k - 1 )} , {τ}_{n} ) \}$$

where k represents the number of layers of tree-like object T, T [symbol] represents a sub-tree growing at position [symbol] , of T^{k}, if k=3, then T [symbol] has two layers and T [symbol] is a simple tree consists of only one main trunk and multiple side branches; if k>3, T [symbol] continues to be defined in a recursive manner until it reaches two layers;
for two complex tree-like objects T^{a,k} and T^{b,k}, their shape dissimilarity is defined as:

$${D}_{\text{?}} ( {T}^{a , k} , {T}^{b , k} ) {λ}_{\text{?}} {d}_{st} ( {q}_{0}^{a} , {q}_{0}^{b} ) + {λ}_{2} {\sum }_{i = 1}^{n} {D}_{s \text{?}} ( {T}_{i}^{a , ( k - 1 )} , {T}_{j ( i )}^{b , ( k - 1 )} ) + {λ}_{\text{?}} {\sum }_{i = 1}^{n} {( {τ}_{i}^{\text{?}} - {τ}_{j ( i )}^{b} )}^{2}$$

$$\text{?} \text{indicates text missing or illegible when filed}$$

the matching of the sub-trees/branches of the two complex trees is also recursively performed using a linear assignment algorithm, and the sum of the differences of all matched sub-trees and branches constitutes the shape dissimilarity of T^{a,k} and T^{b,k}.

Another object of the present disclosure is to provide a system for measuring shape dissimilarity of complex tree-like objects by applying the method for measuring shape dissimilarity of complex tree-like objects, the system comprises:
a branch shape dissimilarity calculation module, configured to measure dissimilarity between two elastic curves by using Euclidean standard;
a simple tree-like object shape dissimilarity calculation module, configured to calculate the shape dissimilarity of simple tree-like objects by constructing a distance matrix to describe the morphological differences between the branches of two trees;
a complex tree-like object shape dissimilarity calculation module, configured to recursively match sub-trees/branches of two complex trees using a linear assignment algorithm, wherein, a sum of the differences of all matched sub-trees and branches constitutes the shape dissimilarity.

Another object of the present disclosure is to provide a computing device, which comprises a memory and a processor, the memory stores a computer program which, when executed by the processor, causes the processor to perform the steps of the method for measuring shape dissimilarity of complex tree-like objects.

Another object of the present disclosure is to provide a computer-readable storage medium, storing a computer program which, when executed by a processor, causes the processor to perform the steps of the method for measuring shape dissimilarity of complex tree-like objects.

Another object of the present disclosure is to provide an information data processing terminal, which is configured to implement the system for measuring shape dissimilarity of complex tree-like objects.

In accordance with the technical solution described above and the technical problems addressed, the advantages and positive effects of the technical solution sought to be protected by the present disclosure are as follows:

Firstly, in view of the technical problems existing in the prior art and the difficulty in solving these problems, a detailed and profound analysis is conducted on how the technical solution of the present disclosure solves the technical problems, and the inventive technical effects brought about after solving the problems. Specific descriptions are as follows:

The present disclosure is directed to a method for measuring shape dissimilarity of complex tree-like objects, such as three-dimensional tree models, neural systems, etc. Initially, skeletal curve information of the branches of its three-dimensional model is extracted. Each branch skeletal curve describes the spatial position information and the thickness of the branch. Tree-like objects are represented iteratively in a hierarchical manner based on the branch skeletal curves as basic building units. Depending on the number of layers, tree-like objects are categorized into simple and complex cases. Simple tree-like objects (hereinafter referred to as “simple trees”) consist of a main branch and several side branches, while complex tree-like objects (hereinafter referred to as “complex trees”) comprise a main branch and several sub-trees, and each sub-tree further consisting of branches and several sub-trees/side branches.

Secondly, viewing the technical solution as a whole or from the product perspective, the technical effects and advantages of the technical solution sought to be protected by the present disclosure are specifically described as follows:
the present disclosure proposes a method for measuring the appearance morphology differences of complex tree-like objects (such as three-dimensional trees, human neural systems), solving the problem that existing methods cannot effectively measure the geometric information and topological structure of complex tree-like objects in a unified manner.

Thirdly, as inventive supplementary evidence for the claims of the present disclosure, the following important aspects are also reflected:
(1) The technical solution of the present disclosure fills a technical gap in the domestic and international industry:
current related work focuses only on research for measuring shape dissimilarity between objects with fixed topological structures. The present disclosure addresses the issue of effective scientific dissimilarity measurement for complex tree-like objects, which has not been deeply considered in existing domestic and international methods. This lays the foundation for subsequent statistical shape analysis and generation tasks for complex tree-like objects.
(2) Whether the technical solution of the present disclosure has solved a technical problem that people have long desired to solve but have not been successful in doing so:
the present disclosure starts with the calculation of corresponding relationships of sampling points on a single branch and the calculation of corresponding relationships for simple tree-like objects, progressing step by step to solve the technical problem of calculating corresponding relationships between topological branching structures of complex tree-like objects.

### BRIEF DESCRIPTION OF THE DRAWINGS

To more clearly elucidate the technical solutions of the embodiments of the present disclosure, a brief description to the drawings needed for the embodiments of the present disclosure will be provided below. It should be readily apparent that the drawings described below are merely some embodiments of the present disclosure, and that those skilled in the art can obtain other drawings based on these drawings without exerting inventive effort.

FIG. 1 is a flowchart illustrating a method for measuring shape dissimilarity of complex tree-like objects provided by an embodiment of the present disclosure;

FIGS. 2A-2C illustrate a trunk curve diagram, a schematic diagram of a simple tree-like object, and a schematic diagram of a complex tree-like object provided by an embodiment of the present disclosure;

FIG. 3 is a diagram illustrating the matching of two trunk curves and the transitional shapes between them, provided by an embodiment of the present disclosure;

FIG. 4 is a schematic diagram illustrating the matching of the trunks of two simple tree-like objects and the transitional shapes between them, provided by an embodiment of the present disclosure;

FIGS. 5A-5B: a schematic diagram illustrating the calculated dissimilarity values of human nervous system morphologies and the transitional shape sequences between them, provided by an embodiment of the present disclosure; wherein, part FIG. 5A is Dₛₜ=24.4, and FIG. 5B is D [symbol] =40.8.

### DETAILED DESCRIPTION

To make the objectives, technical solutions, and advantages of the present disclosure more clear and understandable, the following detailed description is provided in conjunction with the embodiments. It should be understood that the specific embodiments described herein are merely illustrative of the present disclosure and are not intended to limit the scope of the present disclosure.

In view of the problems existing in the prior art, the present disclosure provides a method, a system and a terminal for measuring shape dissimilarity of complex tree-like objects. A detailed description of the present disclosure is provided below in conjunction with the accompanying drawings.

To enable those skilled in the art to fully understand how the present disclosure is specifically implemented, this section serves as an explanatory example that elaborates on the technical solutions set forth in the claims.

The embodiments of the present disclosure provide a method for measuring shape dissimilarity of complex tree-like objects. This dissimilarity includes differences in both geometry and topology. The method is elaborated in a step-by-step manner from the perspectives of individual branch morphological differences, simple tree-like object morphological differences, and complex tree-like object morphological differences.

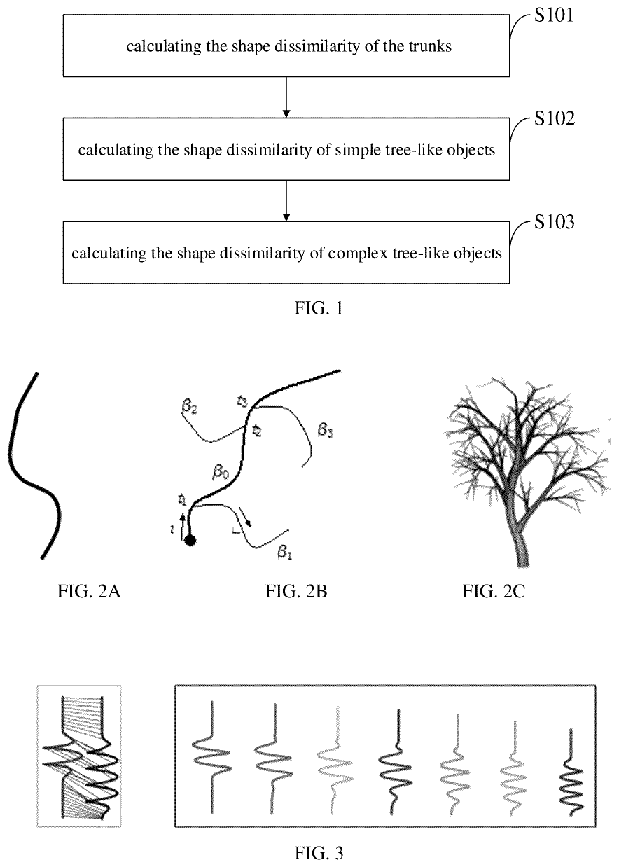

As shown in FIG. 1, the method for measuring shape dissimilarity of complex tree-like objects provided by the embodiments of the present disclosure includes the following steps:
S101, calculating the shape dissimilarity of the trunks;
S102, calculating the shape dissimilarity of simple tree-like objects;
S103, calculating the shape dissimilarity of complex tree-like objects.

The data processed by embodiments of the present disclosure are tree-like objects, such as 3D tree models, nervous systems, etc. Firstly, extracting skeleton curve information from a trunk of a 3D model thereof, each trunk skeleton curve describes spatial position information and thickness of the trunk; secondly, representing the tree-like object using the trunk skeleton curve as a basic structural unit in a hierarchical iterative manner; and thirdly, categorizing the tree-like object as either simple or complex based on the number of layers, as shown in FIG. 2. A simple tree-like object (referred to as “simple tree”) is composed of a main trunk and multiple side branches, a complex tree-like object (referred to as “complex tree”) is composed of a main trunk and multiple sub-trees, and each sub-tree is further composed of a trunk and multiple sub-trees/side branches.

As a preferred embodiment, the method for measuring shape dissimilarity of complex tree-like objects provided by the embodiments of the present disclosure specifically includes the following steps:

### S101. Calculating the Shape Dissimilarity of the Trunks

Calculating the shape dissimilarity of the trunks comprises: considering each trunk β as a continuous curve equipped with trunk radius information in a three-dimensional Euclidean space: β:[0, 1]→ [symbol] [symbol] × [symbol] ⁺, parametrically represented as β=(f(s), r(s))=(x(s), y(s), z(s), r(s)); where x(s), y(s), z(s) is coordinate information of a sample point of the skeleton curve, and r(s) is a radius of the trunk corresponding to the sample point, s ∈ [0, 1] representing a scale value along the arc length of the curve β.

In order to describe the bending and stretching shapes of the trunks, in the present disclosure, the curve f(s) is represented as the corresponding Square Root Velocity Function (SRVF), mathematically represented as:

$$SRVF ( s ) = \{ \begin{matrix}\frac{{f}^{′} ( s )}{\sqrt{‖ {f}^{′} ( s ) ‖}} , & if {f}^{′} ( s ) exists and ‖ {f}^{′} ( s ) ‖ \neq 0 \\ 0 , & otherwise\end{matrix}$$

elastic curve of the trunk β=(f(s), r(s)) is represented as q=(SRVF(s), r(s));
according to the theory of elastic curve, the dissimilarity measurement between two elastic curves uses the Euclidean standard. On this basis, an optimal matching problem between two trunk skeleton curves β₁ and β₂ is a process of finding the re-parameterization function γ:

$$γ \text{?} = arg min ‖ {q}_{1} - γ ( {q}_{2} ) ‖ ;$$

$$\text{?} \text{indicates text missing or illegible when filed}$$

therefore, a distance between the two curves is defined as

$${d}_{s} ( {\text{?}}_{1} , {q}_{2} ) = ‖ {q}_{1} - γ \text{?} ( {q}_{2} ) ‖ ,$$

$$\text{?} \text{indicates text missing or illegible when filed}$$

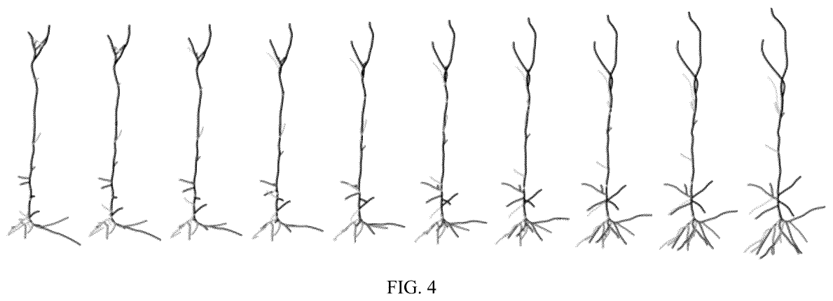

based on a distance metric standard, a matching relationship and morphological transition situation between the two trunk curves are obtained, as shown in FIG. 3.

### S102. Calculating the Shape Dissimilarity of Simple Tree-like Objects

The present disclosure can extend the above method to the task of analyzing the shape of simple tree-like objects, a simple tree comprises a main trunk and n side branches, denoted as (q, τ), where q=[q₀, q₁, q₂, . . . , qₙ], τ=[τ₁, τ₂, . . . , τₙ], q₀ is a SRVF representation of the main trunk, and qₜ is a SRVF representation of the side branches;
for two given simple trees (q^{a}, τ^{a}) and (q^{b}, τ^{b}), the primary challenge faced is how to determine which branch of the first tree matches with which branch of the second tree. To address this issue, in the present disclosure, a distance matrix is constructed to describe the morphological differences between the branches of the two trees, in this process, also allowing a branch to match with a zero branch, and the optimal matching between the branches of the two trees is solved using a linear assignment problem; if the ith branch of the first tree corresponds to the j(i)th branch of the second tree, the shape dissimilarity between the two simple trees is denoted as:

$${d}_{st} ( {q}^{a} , {q}^{b} ) = {λ}_{2} {d}_{s} ( {q}_{0}^{a} , {q}_{0}^{b} ) + {λ}_{2} {\sum }_{i = 1}^{n} {d}_{s} ( {q}_{i}^{a} , {q}_{j ( i )}^{b} ) + {λ}_{3} {\sum }_{i = 1}^{n} {( {τ}_{i}^{a} - {τ}_{j ( i )}^{b} )}^{2}$$

where n=nₐ+n_{b} represents the total number of branches of the two trees, dₛ represents the elastic distance between two branches, λ₁, λ₂, and λ₃ are weights assigned to the differences of the main trunk, the sum of the side branch differences, and the sum of the side branch growth position differences, respectively, in calculating the shape dissimilarity of the sub-trees; a transition shape change between the two simple trees is obtained through this formula in the present disclosure.

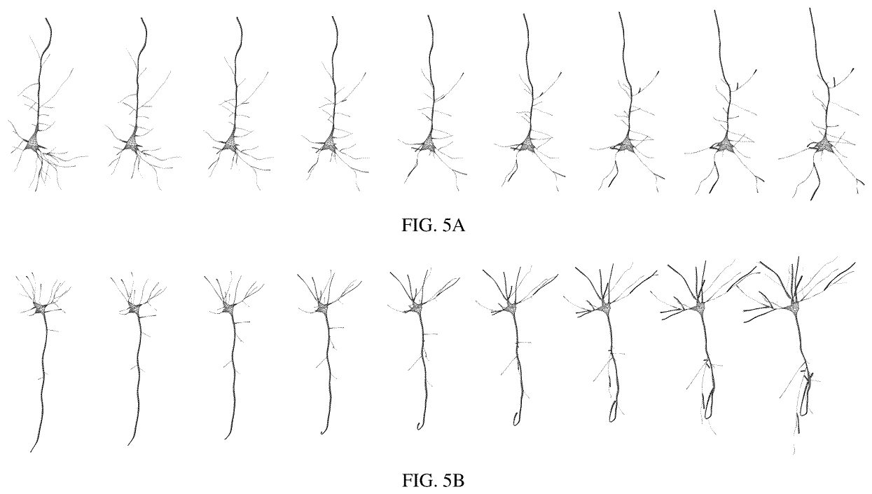

FIG. 4 illustrates the morphological transition between two simple neural system structures, each comprising a single main trunk and multiple side branches. Branches of the same color indicate corresponding branches. This also demonstrates that the distance metric formula proposed by the present disclosure can effectively identify the optimal correspondence between branches of different simple tree structures.

### S103. Calculating the Shape Dissimilarity of Complex Tree-like Objects

based on the representation of simple tree-like objects, a complex tree-like object T is recursively represented as:

$${T}^{k} = \{ {q}_{0} , ( {T}_{1}^{( k - 1 )} , {τ}_{1} ) , ( {T}_{2}^{( k - 1 )} , {τ}_{2} ) , … , ( {T}_{i}^{( k - 1 )} , {τ}_{i} ) , … , ( {T}_{n}^{( k - 1 )} , {τ}_{n} ) \}$$

where k represents the number of layers of tree-like object T, T [symbol] represents a sub-tree growing at position τ [symbol] of T^{k}, if k=3, then T [symbol] has two layers and T [symbol] is a simple tree consists of only one main trunk and multiple side branches; if k>3, T [symbol] continues to be defined in a recursive manner until it reaches two layers;
based on this type of representation, for two complex tree-like objects T^{a,k} and T^{b,k}, similar to the definition of distance in S102, their shape dissimilarity is defined as:

$${D}_{st} ( {T}^{a , k} , {T}^{b , k} ) {λ}_{1} {d}_{st} ( {q}_{0}^{a} , {q}_{0}^{b} ) + {λ}_{2} {\sum }_{i = 1}^{n} {D}_{st} ( {T}_{i}^{a , ( k - 1 )} , {T}_{j ( i )}^{b , ( \text{?} )} ) + {λ}_{\text{?}} {\sum }_{i = 1}^{n} {( {τ}_{i}^{\text{?}} - {τ}_{j ( i )}^{b} )}^{2}$$

$$\text{?} \text{indicates text missing or illegible when filed}$$

the matching of the sub-trees/branches of the two complex trees is also recursively performed using a linear assignment algorithm, and the sum of the differences of all matched sub-trees and branches constitutes the shape dissimilarity of T^{a,k} and T^{b,k}.

Part (a) and (b) of FIG. 5 respectively show the difference values of human nervous system morphology calculated based on the framework of the present disclosure, as well as the transitional morphology sequence between the two. The length of the transitional sequence, denoted as D [symbol] , can serve as a metric for measuring morphological visual differences.

A system for measuring shape dissimilarity of complex tree-like objects provided by embodiments of the present disclosure comprises:
a branch shape dissimilarity calculation module, configured to measure dissimilarity between two elastic curves by using Euclidean standard;
a simple tree-like object shape dissimilarity calculation module, configured to calculate the shape dissimilarity of simple tree-like objects by constructing a distance matrix to describe the morphological differences between the branches of two trees;
a complex tree-like object shape dissimilarity calculation module, configured to recursively match sub-trees/branches of two complex trees using a linear assignment algorithm, wherein, a sum of the differences of all matched sub-trees and branches constitutes the shape dissimilarity.

To demonstrate the inventiveness and technical value of the present disclosure, specific embodiments of the claimed technical solution in terms of its application to particular products or relevant technologies are as follows.

The calculation of shape dissimilarity values between tree-like objects has been applied in various fields. For example, calculating the external morphological differences in the human nervous system can assess the current health status of an individual, thereby aiding medical diagnosis. For plants, calculating the external morphological difference values can effectively analyze the growth conditions of plants and the interactive effects of the surrounding environment, thereby promoting the development of computational biology.

The embodiments of the present disclosure have achieved some positive effects during the research and development or usage process, and indeed possess significant advantages compared to existing technologies. The following content describes these advantages in conjunction with data and charts obtained from experimental processes.

Part (a) and (b) of FIG. 5 respectively show the transitional morphologies and difference values between two complex trees calculated using the complex tree metric method proposed by this disclosure. According to the results of the difference values, the distance metric standard proposed by this disclosure effectively measures the differences in the external appearance of complex tree-like objects, demonstrating the scientific nature of the metric.

It should be noted that the embodiments of the present disclosure can be implemented through hardware, software, or a combination of both. The hardware portion can be realized using dedicated logic; the software portion can be stored in a memory and executed by an appropriate instruction execution system, such as a microprocessor or specially designed hardware. Those skilled in the art will understand that the aforementioned devices and methods can be implemented using computer-executable instructions and/or included in processor control code, for example, provided on media such as disks, CDs, or DVDs, programmable memory such as read-only memory (firmware), or data carriers such as optical or electronic signals. The devices and modules of the present disclosure can be implemented by hardware circuits such as very large-scale integration circuits or gate arrays, semiconductors such as logic chips and transistors, or programmable hardware devices such as field-programmable gate arrays, programmable logic devices, or can be implemented by software executed by various types of processors, or can be implemented by a combination of the aforementioned hardware circuits and software, such as firmware.

The foregoing description is only specific embodiments of the present disclosure, but the scope of protection of the present disclosure is not limited thereto. Any modification, equivalent replacement, or improvement made within the spirit and principle of the present disclosure should fall within the scope of protection of the present disclosure.

1. A method for measuring shape dissimilarity of complex tree-like objects, comprising:
extracting skeleton curve information from a trunk of a 3D model of a tree-like object, wherein each trunk skeleton curve describes spatial position information and thickness of the trunk;
representing the tree-like object using the trunk skeleton curve as a basic structural unit in a hierarchical iterative manner;
categorizing the tree-like object as either simple or complex based on the number of layers;
wherein, a simple tree-like object is composed of a main trunk and multiple side branches, a complex tree-like object is composed of a main trunk and multiple sub-trees, and each sub-tree is further composed of a trunk and multiple sub-trees/side branches.

2. The method for measuring shape dissimilarity of complex tree-like objects of claim 1, wherein, the tree-like object comprises a 3D tree model and a neural system, and the shape dissimilarity of complex tree-like objects comprises differences in geometric information and topological information.

3. The method for measuring shape dissimilarity of complex tree-like objects of claim 1, comprising the following steps:
Step One: calculating the shape dissimilarity of the trunks;
Step Two: calculating the shape dissimilarity of simple tree-like objects;
Step Three: calculating the shape dissimilarity of complex tree-like objects.

4. The method for measuring shape dissimilarity of complex tree-like objects of claim 3, wherein, in Step One, calculating the shape dissimilarity of the trunks comprises:
considering each trunk β as a continuous curve equipped with trunk radius information in a three-dimensional Euclidean space: β:[0, 1]→ [symbol] × [symbol] , parametrically represented as β=(f(s), r(s))=(x(s), y(s), z(s), r(s)); where x(s), y(s), z(s) is coordinate information of a sample point of the skeleton curve, and r(s) is a radius of the trunk corresponding to the sample point, S ⊂ [0, 1] representing a scale value along the arc length of the curve β;
to describe the bending and stretching shapes of the trunks, the curve f(s) is represented as the corresponding Square Root Velocity Function (SRVF), mathematically represented as:
$$SRVF ( s ) = \{ \begin{matrix}\frac{{f}^{′} ( s )}{\sqrt{‖ {f}^{′} ( s ) ‖}} , & if {f}^{′} ( s ) exists and ‖ {f}^{′} ( s ) ‖ \neq 0 \\ 0 , & otherwise\end{matrix}$$
elastic curve of the trunk β=(f(s), r(s)) is represented as q=(SRVF(s), r(s));
according to the theory of elastic curve, the dissimilarity measurement between two elastic curves uses the Euclidean standard; an optimal matching problem between two trunk skeleton curves β₁ and β₂ is a process of finding the re-parameterization function γ:
$$γ \text{?} = arg min ‖ {q}_{1} - γ ( {q}_{2} ) ‖ ;$$
$$\text{?} \text{indicates text missing or illegible when filed}$$
therefore, a distance between the two curves is defined as dₛ(q₁, q₂)=∥q [symbol] −γ [symbol] ( [symbol] )∥, based on a distance metric standard, a matching relationship and morphological transition situation between the two trunk curves are obtained.

5. The method for measuring shape dissimilarity of complex tree-like objects of claim 3, wherein, in Step Two, calculating the shape dissimilarity of simple tree-like objects comprises:
a simple tree comprises a main trunk and n side branches, denoted as (q, τ) where q=[q₀, q₁, q₂, . . . , qₙ], τ=[τ₁, τ₂, . . . , τₙ], q₀ is a SRVF representation of the main trunk, and q [symbol] is a SRVF representation of the side branches;
for two given simple trees (q^{a}, τ^{a}) and (q^{b}, τ^{b}), a distance matrix is constructed to describe the morphological differences between the branches of the two trees, allowing a branch to match with a zero branch, and the optimal matching between the branches of the two trees is solved using a linear assignment problem; if the ith branch of the first tree corresponds to the j(i)th branch of the second tree, the shape dissimilarity between the two simple trees is denoted as:
$${d}_{st} ( {q}^{a} , {q}^{b} ) = {λ}_{2} {d}_{s} ( {q}_{0}^{a} , {q}_{0}^{b} ) + {λ}_{2} {\sum }_{i = 1}^{n} {d}_{s} ( {q}_{i}^{a} , {q}_{j ( i )}^{b} ) + {λ}_{3} {\sum }_{i = 1}^{n} {( {τ}_{i}^{a} - {τ}_{j ( i )}^{b} )}^{2}$$
where n−nₐ+n_{b} represents the total number of branches of the two trees, dₛ represents the elastic distance between two branches, λ₁, λ₂, and λ₃, are weights assigned to the differences of the main trunk, the sum of the side branch differences, and the sum of the side branch growth position differences, respectively, in calculating the shape dissimilarity of the sub-trees; a transition shape change between the two simple trees is obtained through this formula.

6. The method for measuring shape dissimilarity of complex tree-like objects of claim 3, wherein, in Step Three, calculating the shape dissimilarity of complex tree-like objects comprises:
based on the representation of simple tree-like objects, a complex tree-like object T is recursively represented as:
$${T}^{k} = \{ {q}_{0} , ( {T}_{1}^{( k - 1 )} , {τ}_{1} ) , ( {T}_{2}^{( k - 1 )} , {τ}_{2} ) , … , ( {T}_{i}^{( k - 1 )} , {τ}_{i} ) , … , ( {T}_{n}^{( k - 1 )} , {τ}_{n} ) \}$$
where k represents the number of layers of tree-like object T, T [symbol] represents a sub-tree growing at position τ [symbol] of T^{k}, if k=3, then T [symbol] has two layers and T [symbol] is a simple tree consists of only one main trunk and multiple side branches; if k>3, T [symbol] continues to be defined in a recursive manner until it reaches two layers;
for two complex tree-like objects T^{a,k} and T^{b,k}, their shape dissimilarity is defined as:
$${D}_{st} ( {T}_{a , k} , {T}^{b , k} ) = {λ}_{2} {d}_{st} ( {q}_{0}^{a} , {q}_{0}^{b} ) + {λ}_{2} {\sum }_{i = 1}^{n} {D}_{st} ( {T}_{i}^{a , ( k - 1 )} , {T}_{j ( i )}^{b , ( k - 1 )} ) + {λ}_{3} {\sum }_{i = 1}^{n} {( {τ}_{i}^{2} - {τ}_{j ( i )}^{2} )}^{2}$$
the matching of the sub-trees/branches of the two complex trees is also recursively performed using a linear assignment algorithm, and the sum of the differences of all matched sub-trees and branches constitutes the shape dissimilarity of T^{a,k} and T^{b,k}.

7. A system for measuring shape dissimilarity of complex tree-like objects by applying the method for measuring shape dissimilarity of complex tree-like objects of claim 1, wherein, the system comprises:
a branch shape dissimilarity calculation module, configured to measure dissimilarity between two elastic curves by using Euclidean standard;
a simple tree-like object shape dissimilarity calculation module, configured to calculate the shape dissimilarity of simple tree-like objects by constructing a distance matrix to describe the morphological differences between the branches of two trees;
a complex tree-like object shape dissimilarity calculation module, configured to recursively match sub-trees/branches of two complex trees using a linear assignment algorithm, wherein, a sum of the differences of all matched sub-trees and branches constitutes the shape dissimilarity.

8. A computing device, wherein, the computing device comprises a memory and a processor, the memory stores a computer program which, when executed by the processor, causes the processor to perform the steps of the method for measuring shape dissimilarity of complex tree-like objects of claim 1.

9. A computer-readable storage medium, storing a computer program which, when executed by a processor, causes the processor to perform the steps of the method for measuring shape dissimilarity of complex tree-like objects of claim 1.

10. An information data processing terminal, wherein, the information data processing terminal is configured to implement the system for measuring shape dissimilarity of complex tree-like objects of claim 7.
